(19) United States
(12) Patent Application Publication
(10) Pub. No.: US 2017/0163065 A1
(43) Pub. Date: Jun. 8, 2017

(54) CONSTANT POWER SUPPLY FOR THERMO-ELECTRIC CELLS

(71) Applicant: Benjamin Avery Freer, Syracuse, NY (US)

(72) Inventor: Benjamin Avery Freer, Syracuse, NY (US)

(21) Appl. No.: 15/358,224

(22) Filed: Nov. 22, 2016

Related U.S. Application Data
(60) Provisional application No. 62/264,475, filed on Dec. 8, 2015.

(51) Int. Cl. H02J 7/00; H02M 7/44; H05B 33/08; H02M 7/04

(52) U.S. Cl. CPC H02J 7/0052; H02M 7/04; H02M 7/44; H05B 33/0809

(57) ABSTRACT

An electrical circuit can include a power supply that generates a power output. The electrical circuit can also include a load that receives the power output from the power supply. The electrical circuit can further include an electrical conductor coupled to the power supply and the load, where the electrical conductor emits a magnetic field when the power output flows through the electrical conductor to the load. The electrical circuit can also include a response circuit coupled to the power supply and disposed proximate to the electrical conductor, where the response circuit generates a feedback output based on the magnetic field, and where the power output generated by the power supply is based on the feedback output.

### CROSS-REFERENCE TO RELATED APPLICATIONS

This application claims priority under 35 U.S.C. §119 to U.S. Provisional Patent Application Ser. No. 62/264,475, titled “Constant Power Supply For Thermo-Electric Cells” and filed on Dec. 8, 2015, the entire contents of which are hereby incorporated herein by reference.

### TECHNICAL FIELD

The present disclosure relates generally to temperature control devices, and more particularly to systems, methods, and devices for thermo-electric cells.

### BACKGROUND

A number of temperature control devices exist today that are used to control temperature and related conditions (e.g., humidity) in a space. One such temperature control device is a thermo-electric cell (TEC), also called a thermo-electric cooler. A TEC can be used for cooling or heating. Unfortunately, a thermo-electric cell can be sensitive to ambient temperatures as well as heat transferred, either of which can affect the performance of the thermo-electric cell.

### SUMMARY

In general, in one aspect, the disclosure relates to an electrical circuit. The electrical circuit can include a power supply that generates a power output. The electrical circuit can also include a load that receives the power output from the power supply. The electrical circuit can further include an electrical conductor coupled to the power supply and the load, where the electrical conductor emits a magnetic field when the power output flows through the electrical conductor to the load. The electrical circuit can also include a response circuit coupled to the power supply and disposed proximate to the electrical conductor, where the response circuit generates a feedback output based on the magnetic field, and where the power output generated by the power supply is based on the feedback output.

In another aspect, the disclosure can generally relate to a power supply for providing a substantially constant level of power to a load. The power supply can include a first input channel configured to receive main power from a power source. The power supply can also include a second input channel configured to receive feedback output from a response circuit. The power supply can further include an output channel configured to deliver the substantially constant level of power to the load. The power supply can also include a controller that receives the feedback output through the second input channel and generates, based on the output from the feedback output, the substantially constant level of power.

In yet another aspect, the disclosure can generally relate to a system. The system can include an enclosure having at least one wall that forms a cavity. The system can also include a device disposed within the cavity, where the device is adversely affected by an abnormal ambient condition within the cavity. The system can further include a power supply that generates a power output. The system can also include a load disposed within the cavity, where the load receives the power output from the power supply, and where the load reduces the moisture within the cavity. The system can further include an electrical conductor coupled to the power supply and the load, where the electrical conductor is disposed within the cavity and emits a magnetic field when the power output flows through the electrical conductor to the load. The system can also include a response circuit coupled to the power supply and disposed proximate to the electrical conductor within the cavity, where the response circuit generates a feedback output based on the magnetic field, and where the power output generated by the power supply is based on the feedback output.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIG. 1 shows a thermo-electric cell currently known in the art.

FIG. 2 shows a graph of temperature differential and voltage for a thermo-electric cell currently known in the art.

FIG. 3 shows a graph of current and temperature differential at a constant voltage for a thermo-electric cell currently known in the art.

FIGS. 4A and 4B show an electrical circuit to provide constant power to a thermo-electric cell in accordance with certain example embodiments.

FIG. 5 shows a graph comparing constant voltage versus constant power delivered to a thermo-electric cell at different ambient temperatures.

FIG. 6 shows a graph of temperature differential and power for a thermo-electric cell in accordance with certain example embodiments.

FIG. 7 shows a system diagram that includes a controller in accordance with certain example embodiments.

FIG. 8 shows a computing device in accordance with one or more example embodiments.

FIGS. 9A and 9B show a system 900 in which one or more example embodiments can be used.

### DETAILED DESCRIPTION

In general, example embodiments provide systems, methods, and devices for constant power supply for TECs. Example constant power supply for TECs can be used in any of a number of applications, including but not limited to electrical enclosures (e.g., junction boxes, conduit, control panels), electrical devices (e.g., light fixture, switch), and mechanical devices (relay contact, contactor). Further, example constant power supply for TECs can be used in one or more of any of a number of environments, including but not limited to hazardous (e.g., explosive) environments, indoors, outdoors, cold temperatures, hot temperatures, high humidity, marine environments, and low oxygen environments. A user may be any person that interacts, directly or indirectly, with TECs. Examples of a user may include, but are not limited to, an engineer, an electrician, an instrumentation and controls technician, a mechanic, an operator, a consultant, a contractor, and a manufacturer's representative.

In the foregoing figures showing example embodiments of constant power supply for TECs, one or more of the components shown may be omitted, added, repeated, and/or substituted. Accordingly, example embodiments of constant power supply for TECs should not be considered limited to the specific arrangements of components shown in any of the figures. For example, features shown in one or more figures or described with respect to one embodiment can be applied to another embodiment associated with a different figure or description.

Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three digit number and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

In some cases, example constant power supplies for TECs can be used in electrical enclosures. As defined herein, an electrical enclosure is any type of cabinet or housing inside of which is disposed one or more electrical and/or mechanical devices. Such electrical and/or mechanical devices can include, but are not limited to, variable frequency drives (VFDs), controllers, relays (e.g., solid state, electro-mechanical), contactors, breakers, switches, transformers, inverters, converters, fuses, electrical cables, thermo-electric coolers (TECs), heating elements, air moving devices (e.g., fans, blowers), terminal blocks, wire nuts, and electrical conductors. In some cases, an electrical and/or mechanical device can generate heat when operating. Electrical devices can also include mechanical components and/or mechanical devices that are controlled by an electrical device. Examples of an electrical enclosure can include, but are not limited to, an electrical connector, a junction box, a motor control center, a breaker cabinet, an electrical housing, a conduit, a control panel, an electrical receptacle, a lighting panel, a lighting device, a relay cabinet, an indicating panel, and a control cabinet.

Example embodiments are designed to control an amount of power supplied to a TEC. A TEC can be used to control temperature and/or moisture within an electrical enclosure within a range of values, above a minimum value, and/or below a maximum value. Example embodiments can operate continuously, at regular intervals, when one or more conditions (e.g., moisture) within an electrical enclosure falls outside a range of values, on-demand from a user, and/or according to some other schedule.

In certain example embodiments, electrical enclosures in which example constant power supplies for TECs are used are subject to meeting certain standards and/or requirements. For example, the National Electric Code (NEC), the National Electrical Manufacturers Association (NEMA), the International Electrotechnical Commission (IEC), and the Institute of Electrical and Electronics Engineers (IEEE) set standards as to electrical enclosures, wiring, and electrical connections. Use of example embodiments described herein meet (and/or allow a corresponding device and/or electrical enclosure to meet) such standards when required. In some (e.g., PV solar) applications, additional standards particular to that application may be met by the electrical enclosures in which example constant power supply for TECs are used.

As discussed above, example embodiments can be used in hazardous environments or locations. Examples of a hazardous location in which example embodiments can be used can include, but are not limited to, an airplane hangar, a drilling rig (as for oil, gas, or water), a production rig (as for oil or gas), a refinery, a chemical plant, a power plant, a mining operation, and a steel mill. A hazardous environment can include an explosion-proof environment, which would require an electrical enclosure with an example constant power supply for a TEC to meet one or more requirements, including but not limited to flame paths.

Example embodiments of constant power supply for TECs will be described more fully hereinafter with reference to the accompanying drawings, in which example embodiments of constant power supply for TECs are shown. Constant power supply for TECs may, however, be embodied in many different forms and should not be construed as limited to the example embodiments set forth herein. Rather, these example embodiments are provided so that this disclosure will be thorough and complete, and will fully convey the scope of constant power supply for TECs to those of ordinary skill in the art. Like, but not necessarily the same, elements (also sometimes called components) in the various figures are denoted by like reference numerals for consistency.

Terms such as “first”, “second”, “top”, “bottom”, “side”, “width”, “length”, “inner”, and “outer are used merely to distinguish one component (or part of a component or state of a component) from another. Such terms are not meant to denote a preference or a particular orientation, and are not meant to limit embodiments of constant power supply for TECs. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

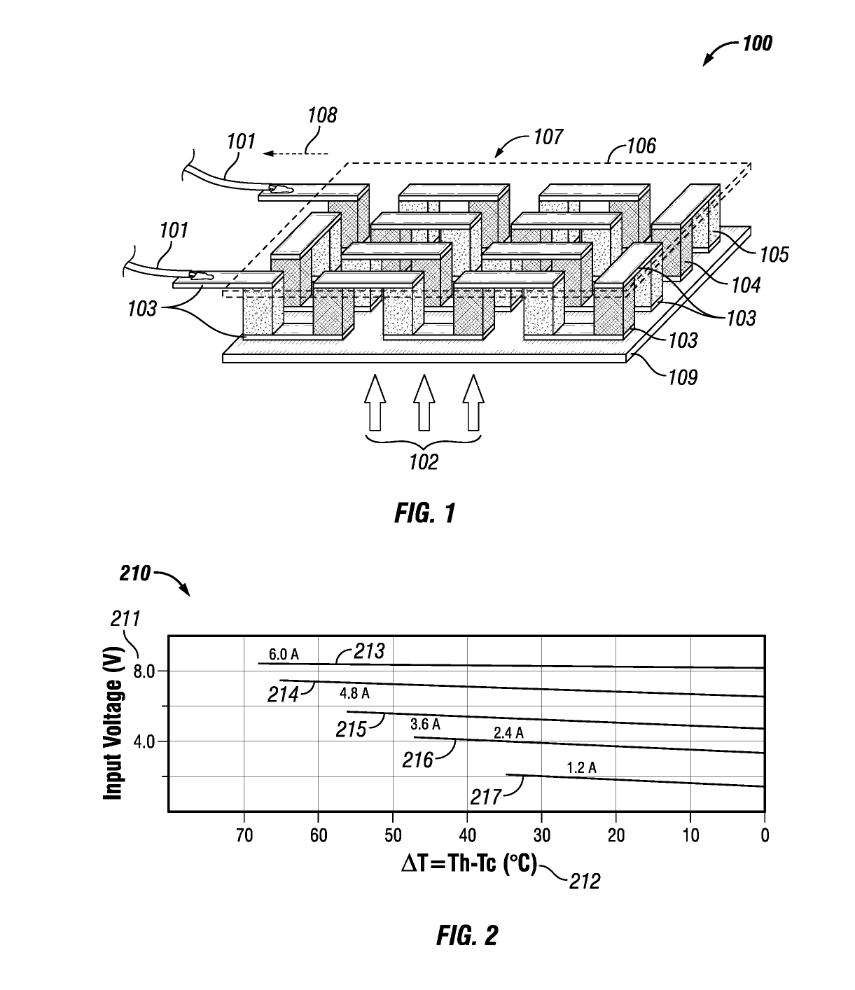

FIG. 1 shows a system 100 that includes a TEC 107 currently known in the art. Referring now to FIG. 1, the TEC 107 operates using the Peltier effect (also known as the thermoelectric effect). The TEC 107 of FIG. 1 includes plate 106 and plate 109, which are both thermally conductive. Plate 106 and plate 109 can have substantially the same characteristics (e.g., length, thickness, width, composition of material) as each other. Disposed between plate 106 and plate 109 are a number of p-type semiconductors 105, a number of n-type semiconductors 104, and a number of jumpers 103. The p-type semiconductors 105, the n-type semiconductors 104, and the jumpers 103 are arranged in such a way that the p-type semiconductors 105 and the n-type semiconductors 104 are electrically in series with each other and thermally in parallel with each other.

Specifically, a jumper 103 is coupled to one end of a p-type semiconductor 105 and one end of an adjacent n-type semiconductor 109. In this way there is a serpentine path, both vertically and horizontally, between alternating p-type semiconductors 105 and n-type semiconductors 109, where a jumper 103 is used to provide the connection between adjacent p-type semiconductors 105 and n-type semiconductors 109. At each end of this serpentine chain is a jumper 103 that is coupled at one end to a semiconductor (e.g., p-type semiconductor 105, n-type semiconductor 109) and to an electrical conductor 101 at the other end. In such a case, the jumper 103 can extend beyond the outer perimeter of plate 106 and/or plate 109.

Power (e.g., a voltage) is applied to one of the electrical conductors 101 that is coupled to a jumper 103 of the TEC 107. The power can be alternating current (AC), applying AC power to a TEC 107 often results in ineffective performance of the TEC 107. Much more often, direct current (DC) power is applied to the TEC 107. When the power is applied to the electrical conductor 101, current flows through the serpentine path formed by the p-type semiconductors 105, the n-type semiconductors 104, and the jumpers 103. Eventually, the current exits through the other electrical conductor 101 at the other end of the serpentine chain of the TEC 107.

As the current flows through the TEC 107, heat flows from one plate (e.g., plate 109) to the other plate (e.g., plate 106). The hotter plate (e.g., plate 106) can be coupled to a heat sink, so that the heat 102 absorbed by the cooler plate and transferred to the hotter plate is in turn transferred to the heat sink, which keeps the hotter plate at approximately ambient temperature. At the same time, the cooler plate is at a temperature below ambient temperature.

FIG. 2 shows a graph 210 of temperature differential 212 and voltage 211 for an example thermo-electric cell (e.g., TEC 107) currently known in the art. Referring to FIGS. 1 and 2, the voltage 211 is represented on the vertical axis of the graph 210, and the temperature differential 212 is represented on the horizontal axis. The voltage 211 is the amount of DC volts applied to one of the electrical conductors 101 coupled to the TEC 107. The temperature differential 212 is the difference in temperature (in ° C.) between the hotter plate (e.g., plate 106) and the cooler plate (e.g., plate 109) of the TEC 107.

Each curve in the graph 210 is substantially linear and represents a current, which corresponds to the voltage 211 applied to the TEC 107. In this case, curve 213 is 6.0 A, which corresponds to a voltage 211 of slightly more than 8V ranging from a temperature differential 212 between 0° C. and approximately 68° C. To keep the current constant at 6.0 A, the voltage 211 must increase slightly as the temperature differential 212 increases. As the graph 210 shows, as the constant current decreases, the input voltage 211 must increase more and more, which causes a greater negative slope to each curve. Thus, the slope of curve 214 is slightly more negative than the slope of curve 213; the slope of curve 215 is slightly more negative than the slope of curve 214; the slope of curve 216 is slightly more negative than the slope of curve 215; and the slope of curve 217 is slightly more negative than the slope of curve 216.

Also, as the constant current decreases, the range of temperature differentials 212 decreases because the TEC 107 is not receiving enough power at lower currents to maintain a higher temperature differential 212. In this case, curve 214 (representing 4.8 A) spans from 0° C. to approximately 65° C.; curve 215 (representing 3.6 A) spans from 0° C. to approximately 56° C.; curve 216 (representing 2.4 A) spans from 0° C. to approximately 47° C.; and curve 217 (representing 1.2 A) spans from 0° C. to approximately 35° C. Graph 210 of FIG. 2 shows that TEC 107 is essentially a resistive load, but is highly sensitive to temperature (e.g., ambient temperature to which the TEC 107 is subjected) and heat transferred (e.g., temperature differential between plates of the TEC 107).

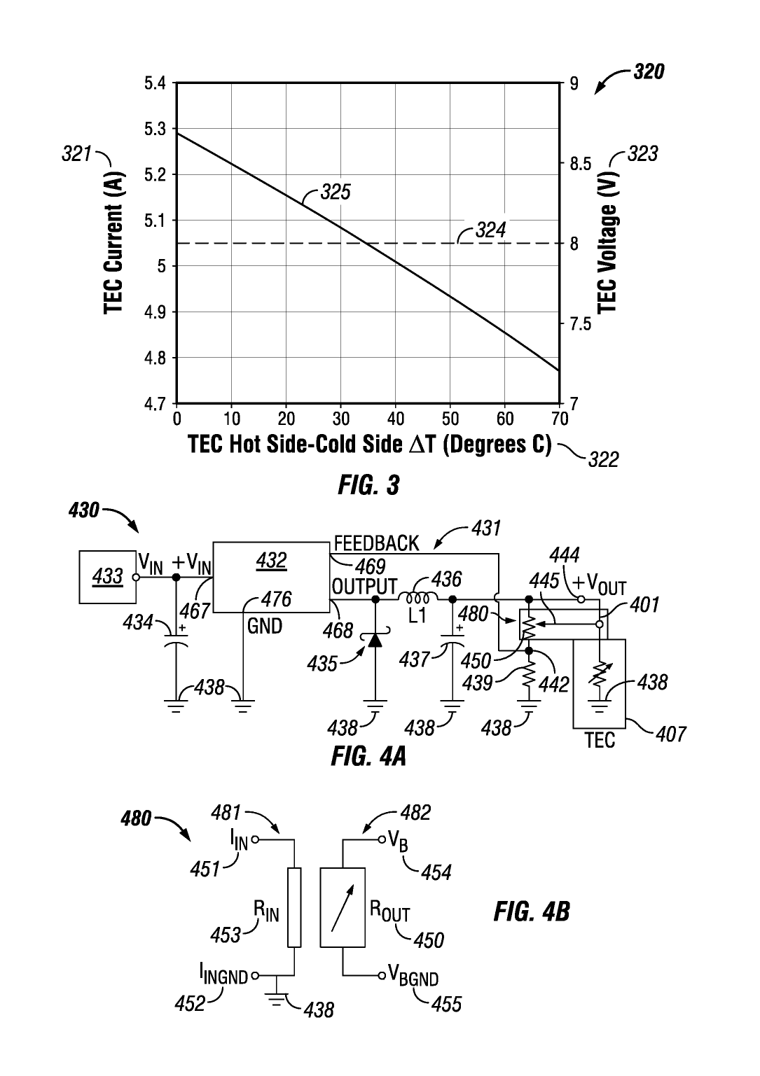

FIG. 3 shows a graph 320 of current 321 and temperature differential 322 at a constant voltage 323 for an example TEC (e.g., TEC 107) currently known in the art. Referring to FIGS. 1-3, in this case, the voltage applied to the TEC 107 is held constant at 8V. As a result, with no temperature differential 322 between the hotter plate (e.g., plate 106) and the cooler plate (e.g., plate 109), the current 321 that flows through the TEC 107 is approximately 5.28 A. At the other extreme, when the temperature differential 322 between the hotter plate and the cooler plate of the TEC 107 is 70° C., the current 321 that flows through the TEC 107 is approximately 4.76 A. Between these two points, there is a linear relationship (represented by curve 325) between current 321 and temperature differential 322 at constant voltage 323.

In other words, the graph 320 of FIG. 3 shows that, for a constant voltage power supply, the initial (i.e., when the temperature differential 322 is low) power (a product of current 321 and voltage 323) supplied to the TEC 107 can be significantly greater than the power supplied to the TEC 107 during steady-state operation (e.g., when the temperature differential 322 is high). Similarly, the power supplied to a TEC 107 can be constant current (as opposed to constant voltage), which still requires significantly greater power supplied to the TEC 107 during low temperature differential 322 compared to when the temperature differential 322 is high. Using example embodiments, constant power (rather than constant voltage or constant current) is delivered to the TEC 107.

FIGS. 4A and 4B shows an electrical circuit 430 to provide constant power to a TEC 407 in accordance with certain example embodiments. Specifically, FIG. 4A shows a power supply 431 coupled to and providing constant voltage to the TEC 407. FIG. 4B shows the detail of an example response circuit 480 of the electrical circuit 430 of FIG. 4A, which enables the power supply 431 to provide constant power to the TEC 407. Referring to FIGS. 1-4B, the TEC 407 of FIG. 4A is substantially similar to the TEC 107 of FIG. 1, and the electrical conductor 401 of FIG. 4A is substantially similar to the electrical conductor 101 of FIG. 1.

The power supply 431 of the electrical circuit 430 (less the example response circuit 480 shown in FIG. 4B) can be a constant voltage power supply or a constant current power supply. In other words, example embodiments can be based on retrofitting an existing power supply that supplies constant voltage or constant current to a TEC 407. Alternatively, the power supply 431 of the electrical circuit 430 (less the example response circuit 480 shown in FIG. 4B) can supply any other type of power to the TEC 407. In this case, the power supply 431 is a standard buck supply for providing constant voltage that is modified, substituting the resistor 450 of FIG. 4A with the example response circuit 480 of FIG. 4B, to include a secondary current feedback path in addition to the standard voltage feedback path.

The power supply 431 of FIG. 4A is powered by a power source 433, which is also electrically coupled to a capacitor 434 (which, in turn, is electrically coupled to ground 438). Specifically, the power source 433 is coupled to an input channel 467 of a controller 432. The example controller 432 can also have an output channel 468, an optional ground channel 476, and at least one additional input channel 469. In this case, the ground channel 476 is electrically coupled to ground 438. The additional input channel 469 (also called a feedback channel 469) is a feedback leg that is electrically coupled to terminal point 442. The output channel 468 is an output leg that is electrically coupled to a load 407, in between which are disposed a diode 435 (which, in turn, is electrically coupled to ground 438) and an inductor 436.

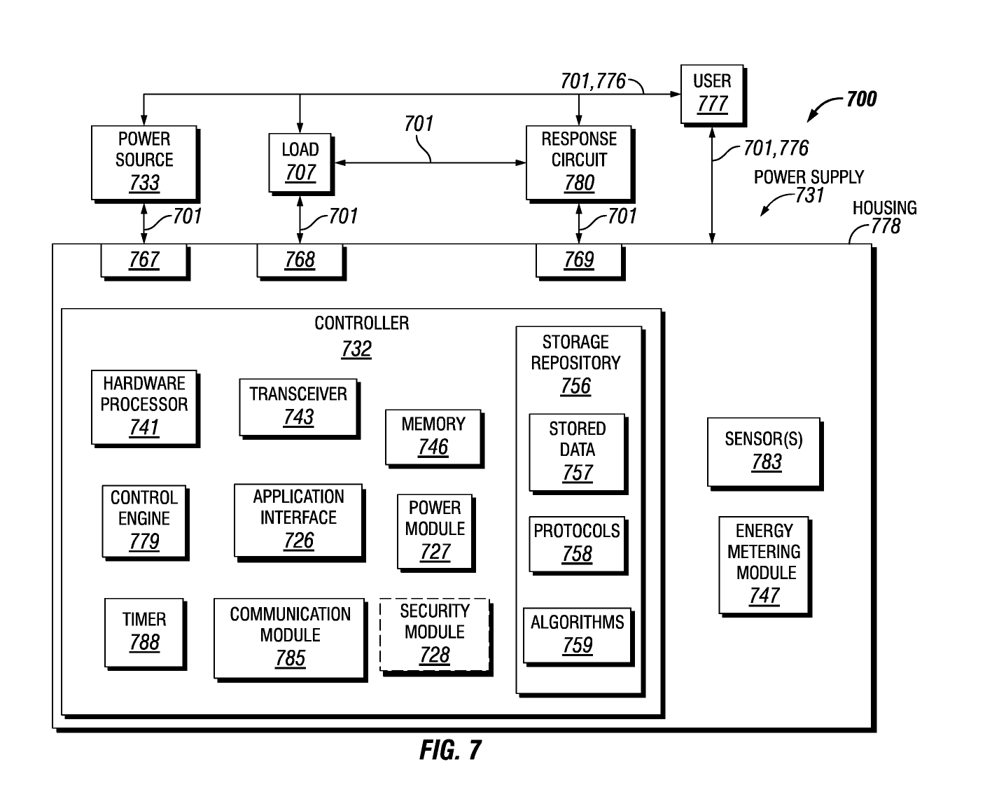

The controller 432 can have one or more of any of a number of components (e.g., a hardware processor, a switch, an integrated circuit, a resistor, a capacitor, a relay), and is configured to receive feedback (traditionally, only voltage or current, but both voltage and current in example embodiments) and generate power based on the feedback. For example, the controller 432 can include a number of discrete components (e.g., integrated circuits, resistors, capacitors) that are coupled to each other. As another example, a controller 432 can be a solid-state device having a housing. A detailed example of a controller is shown below with respect to FIG. 7.

The inductor 436 is electrically coupled to terminal point 444, which also has electrically coupled thereto a capacitor 437 (which, in turn, is electrically coupled to ground 438), a resistor 450, and the load 407, which in this case is a TEC. Thus, electrical conductor 401, which feeds power generated by the power supply 431 to the load 407, is also electrically coupled to terminal point 444. To complete the description of the power supply 431, terminal point 442 also has electrically coupled thereto response circuit 480 (which, in the case of FIG. 4A, includes resistor 450) and resistor 439 (which, in turn, is electrically coupled to ground 438). In some cases, the load 407 is also electrically coupled to ground 438.

In certain example embodiments, feedback provided by the example response circuit 480 of FIG. 4B to the controller 432 of the power supply 431 is based on a magnetic field 445 that emanates from the electrical conductor 401 as power flows from the power supply 431 through the electrical conductor 401 to the load 407. In such a case, the strength of the magnetic field 445 is proportional to the amount of current flowing through electrical conductor 401 to the load 407.

When the power supply 431 is configured to provide constant voltage, as in the case with the standard buck supply of FIG. 4A, the response circuit 480 provides current feedback, based on the magnetic field 445, to the controller 432 so that the power supply 431 provides constant power (rather than constant voltage) to the load 407. When the power supply 431 is configured to provide constant current, the response circuit 480 provides voltage feedback, based on the magnetic field 445, to the controller 432 so that the power supply 431 provides constant power (rather than constant current) to the load 407.

For effective operation, in certain example embodiments, the response circuit 480 is placed in close proximity to the electrical conductor 401 so that the magnetic field 445 can be sensed by the response circuit 480. The response circuit 480 can have any of a number of configurations. For example, as shown in FIG. 4B, the response circuit 480 includes a bias circuit 481 and a sensor circuit 482. The bias circuit 481 of FIG. 4B includes an input terminal 451, an output terminal 452, and a bias resistor 453 electrically disposed between the input terminal 451 and the output terminal 452. In some cases, the output terminal 452 is electrically coupled to ground 438.

The power delivered to the input terminal 451 of the bias circuit 481 can be delivered by the power supply 431. Alternatively, the power delivered to the input terminal 451 of the bias circuit 481 can be delivered by some other source of power (e.g., a battery, another power supply). In such a case, When power flows to the input terminal 451, the bias resistor 453 turns on the response circuit 480. Once the response circuit 480 is turned on by the bias resistor 453, the sensor circuit 482 measures the magnetic field 455.

The sensor circuit 482 includes an input terminal 454, an output terminal 455, and a resistor 450, which in this case acts as a sensor. In certain example embodiments, the input terminal 454 of the sensor circuit 482 is electrically coupled to terminal point 444, and the output terminal 455 is electrically coupled to terminal point 442. Alternatively, the input terminal 454 of the sensor circuit 482 can receive power from another source of power (e.g., the source of power that feeds the input terminal 451 of the bias circuit 481). In such a case, the resistor 450 can have a separate input terminal and output terminal that are electrically coupled to terminal point 444 and terminal point 442, respectively.

In certain example embodiments, the resistor 450 is a variable resistor that varies its resistance based on the magnetic field. In cases such as this, the resistor 450 operates at high frequencies. As an example of how the resistor 450 works, as the current that flows through the electrical conductor 401 feeding the load 407 in increases, the magnetic field 455 strengthens. As magnetic field 455 strengthens, the resistor 450 adjusts its variable resistance downward, which provides a stronger negative feedback signal to the feedback terminal of the controller 432 of the power supply 431. As a result, the controller 432 of the power supply 431 lowers the voltage delivered to the TEC 407 through the output terminal of the controller 432. In other words, this closed-loop system, using example embodiments, allows for a substantially constant (e.g., +/−4%) power supply to the load 407.

By using example embodiments to deliver substantially constant power to the load 407 (which, again, in this case is a TEC), regardless of operating conditions (e.g., ambient temperature to which the load 407 is exposed, the temperature differential between the plates of the load 407), the load 407 can be more finely and accurately controlled, which improves the performance (e.g., regulate temperature, reduce humidity) of the load 407. Those of ordinary skill in the art will appreciate that the response circuit 480 can have any of a number of other configurations to allow a constant voltage or a constant current power supply 431 to generate and deliver constant power to a load 407.

In addition, example embodiments can be used in other applications aside from providing power to a load 407 that is a TEC. For example, certain embodiments can be used to help deliver substantially constant power to a load 407 that includes one or more light-emitting diodes (LEDs). When LEDs are fed by a constant current supply, as is common in the art today, the forward voltage of the LEDs lowers as the LEDs warm up (are turned on after being off). As a result, the output of light emitted by the LED is reduced. Using example embodiments to change the constant current supply to a constant power supply, the output of light emitted by LEDs can be substantially constant, regardless of the effects of warm up and/or other factors that can otherwise effect the output of light emitted by the LED.

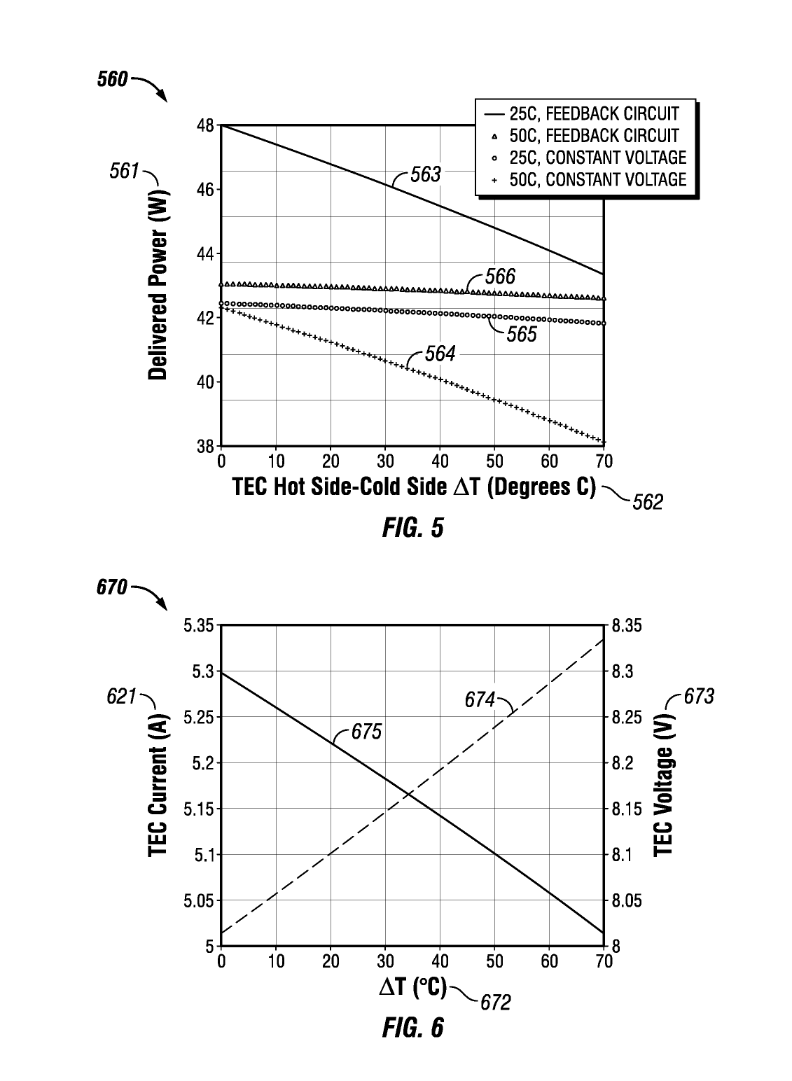

FIG. 5 shows a graph 560 comparing power 561 delivered to a TEC and temperature differential 562 of the TEC at different ambient temperatures. Referring to FIGS. 1-5, the graph 560 shows four curves (curve 563, curve 564, curve 565, and curve 566) that are each substantially linear across the range of temperature differentials 562 of the TEC (in this case, the load 407). Curve 563 and curve 564 represents power delivered by a power source such as the power source 431 shown in FIG. 4A, where resistor 450 is used instead of an example response circuit 480. As a result, the power source 431 delivers constant voltage or constant current (but not constant power) to the load 407.

As stated above, the performance of a TEC can vary both with respect to the temperature differential 562 between plates of the TEC, but also with the ambient temperature. Curve 563 represents power 561 versus temperature differential 562 at an ambient temperature of 25° C., and curve 564 represents power 561 versus temperature differential 562 at an ambient temperature of 50° C. At higher ambient temperatures, less power 561 is required by the TEC. However, without example response circuits, the power 561 delivered by the power source 431 varies widely. Specifically, as shown by curve 563, when the ambient temperature is 25° C., the power 561 ranges from about 43.5 W at a temperature differential 562 of 70° C. and about 48 W when there is no temperature differential 562. Similarly, as shown by curve 564, when the ambient temperature is 50° C., the power 561 ranges from about 38.2 W at a temperature differential 562 of 70° C. and about 42.4 W when there is no temperature differential 562.

By contrast, example embodiments allow the power source 431 to generate a substantially constant power (as opposed to only a constant voltage or a constant current) across the range of temperature differentials 562 of the TEC. For example, as shown by curve 565, when the ambient temperature is 25° C., the power 561 ranges from about 41.8 W at a temperature differential 562 of 70° C. and about 42.4 W when there is no temperature differential 562. Similarly, as shown by curve 566, when the ambient temperature is 50° C., the power 561 ranges from about 42.5 W at a temperature differential 562 of 70° C. and about 43.1 W when there is no temperature differential 562.

FIG. 6 shows a graph 670 of current 671 and voltage 673 versus temperature differential 672 for constant power delivered to a TEC (in this case, the load 407) in accordance with certain example embodiments. Referring to FIGS. 1-6, in this case, since the power delivered to the TEC is held constant, and since power is the product of voltage 673 and current 671, the voltage 673 (depicted by curve 674) and current 671 (depicted by curve 675) are inversely linearly related to each other. When there is no temperature differential 672 between the hotter plate (e.g., plate 106) and the cooler plate (e.g., plate 109) of the TEC, the current 671 that flows through the TEC is slightly less than 5.3 A, and the voltage 673 applied to the TEC is approximately 8.02V for a power level of approximately 42.5 W.

At the other extreme, when the temperature differential 672 between the hotter plate and the cooler plate of the TEC is 70° C., the current 671 that flows through the TEC is approximately 5.02 A and the voltage 673 applied to the TEC is approximately 8.33V for a power level of approximately 41.8 W. Thus, as discussed above with respect to FIG. 5, the power level is substantially constant over the range of temperature differentials 672 of the TEC using example embodiments.

FIG. 7 shows a system diagram 700 that includes a power supply 731 with a controller 732 in accordance with certain example embodiments. In addition to the power supply 731, the system 700 of FIG. 7 can include one or more loads 707, one or more response circuits 780, a user 777, and one or more power sources 733. The controller 732 can include one or more of a number of components. Such components, can include, but are not limited to, a control engine 779, a communication module 785, a timer 788, a power module 727, a storage repository 756, a hardware processor 741, a memory 746, a transceiver 743, an application interface 726, and, optionally, a security module 728. In addition to the controller 732, the power supply 731 can include a one or more of a number of other components, including but not limited to one or more sensors 783, an energy metering module 747, a power transfer device (not shown), and one or more switches (not shown).

The components shown in FIG. 7 are not exhaustive, and in some embodiments, one or more of the components shown in FIG. 7 may not be included in an example power supply 731. Any component of the example power supply 731 can be discrete or combined with one or more other components of the power supply 731. In addition, the location of one or more components can vary from what is shown in FIG. 7. For example, the power supply 731 may not have a local controller 732 disposed, at least in part, within the housing 778 of the power supply 731. Instead, the controller 732 can be located remotely from the power supply 731 and communicate with the power supply 731 using one or more electrical conductors 701 (substantially the same as the electrical conductors described above) and/or communication links 776. A communication link 776 can include or be part of a network using wireless technology (e.g., Wi-Fi, Zigbee, 6LoPan). As another example, one or more of the sensors 783 can be part of the controller 732.

The user 777 is the same as a user defined above. The user 777 can interact with (e.g., sends data to, receives data from) the controller 732 of the power supply 731 via the application interface 726 (described below). The user 777 can also interact with the power source 733, the response circuit 780, and/or the load 707. Interaction between the user 777 and the power supply 731, the power source 733, the response circuit 780, and the load 707 can be conducted using electrical conductors 701 and/or communication links 776. The communication links 776 can transmit signals (e.g., communication signals, control signals, data) between the power supply 731 and the user 777, the power source 733, the response circuit 780, and/or the load 707.

A load 707 can be substantially the same as a load described above. In certain example embodiments, the load 707 is coupled to the power supply 731 using, for example, one or more electrical conductors 701. In some cases, there can be more than one load 707 coupled to the power supply 731. In such a case, the power supply 731 can have a single controller 732 that generates a constant power output for the multiple loads 707. Alternatively, a power supply 731 can have multiple controllers 732, where each controller 732 provides a constant power output to at least one load 707. When there is a single controller 732 for multiple loads 707, the controller 732 can have multiple output channels 768 or a single output channel 768.

A response circuit 780 can be substantially the same as a response circuit described above. In certain example embodiments, the response circuit 780 is coupled to the power supply 731 using, for example, one or more electrical conductors 701. In some cases, there can be more than one response circuit 780 coupled to the power supply 731. In such a case, the power supply 731 can have a single controller 732 that receives a feedback output for the response circuits 780. Alternatively, a power supply 731 can have multiple controllers 732, where each controller 732 receives a feedback output from at least one response circuit 780. When there is a single controller 732 for multiple response circuits 780, the controller 732 can have multiple input channels 769 or a single input channel 769.

The energy metering module 747 of the power supply 731 can measure and/or monitor one or more parameters associated with the load 707, the response circuit 780, and/or any other component of the system 700. Examples of such parameters can include, but are not limited to, current, voltage, resistance, VARs, watts, Joules, and therms. For example, the energy metering module 747 can measure power consumption of the load 707. As another example, the energy metering module 747 can measure the current of a feedback output. In certain example embodiments, an load 707 is coupled to an output channel 768 of the power supply 731, and the energy metering module 747 measures power fed through the output channel 768.

The energy metering module 747 can include any of a number of measuring devices and related devices, including but not limited to a voltmeter, an ammeter, a power meter, an ohmmeter, a resistor, an opto-coupler, a transistor, a current transformer, a potential transformer, and electrical wiring. The energy metering module 747 can measure a component of energy (e.g., power) continuously, periodically, based on the occurrence of an event, based on a command received from the control engine 779, randomly, and/or based on some other factor. The energy metering module 747 and/or other components of the power supply 731 can receive power, control, and/or communication signals from the power module 727.

Each sensor 783 (also called a sensor device 783 herein) of the power supply 731 can be used to measure one or more parameters, not measured by the energy metering module 747, that are associated with one or more components (e.g., the load 707, the response circuit 780, a device (defined below), the controller 732) of the system 700. The measurements taken by the sensor 783 can be received by the controller 732 to help the controller 732 determine when and how to adjust the power output sent through the output channel 768 to the load 707. Examples of a sensor 783 can include, but are not limited to, a temperature sensor, a pressure sensor, a photocell, a water level detector, and a humidity sensor. Examples of parameters that a sensor 783 can measure can include, but are not limited to, humidity, temperature, dew point, fluid level, and pressure.

The controller 732 of a power supply 731 can interact (e.g., periodically, continually, randomly) with the load 707, the response circuit 780, the power source 733, and/or the user 777. The user 777, the power source 733, the response circuit 780, and/or the load 707 can interact with the controller 732 of the power supply 731 using the application interface 726, the electrical conductors 701, and/or the communication links 776 in accordance with one or more example embodiments. Specifically, the application interface 726 of the controller 732 receives data (e.g., information, communications, instructions) from and sends data (e.g., information, communications, instructions) to the user 777, the power source 733, the response circuit 780, and/or the other load 707.

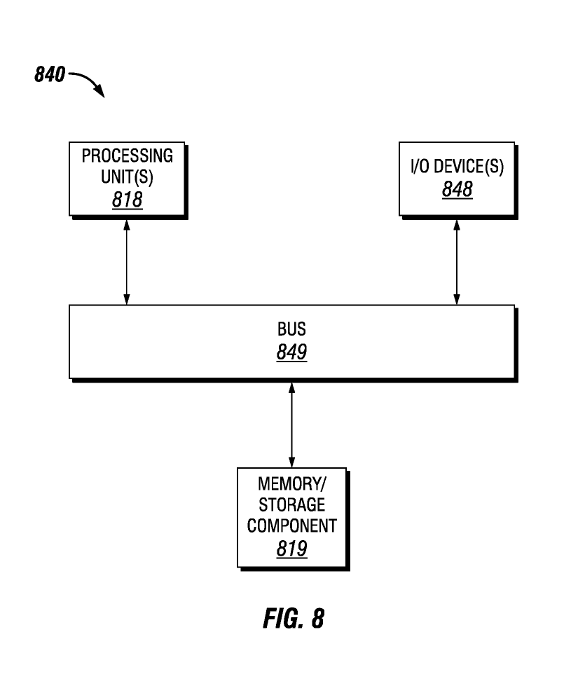

The controller 732, the user 777, the power source 733, the response circuit 780, and/or the load 707 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 732. Examples of such a system can include, but are not limited to, a desktop computer with LAN, WAN, Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 8.

Further, as discussed above, such a system can have corresponding software (e.g., user software, controller software, power source software, electrical device software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, Local Area Network (LAN), Wide Area Network (WAN), or other network communication methods) and/or communication channels, with wire and/or wireless segments (communication links 776) according to some example embodiments. The software of one system can be a part of, or operate separately but in conjunction with, the software of another system within the system 700.

As discussed above, the power supply 731 can include a housing 778. The housing 778 can include at least one wall that forms a cavity. The housing 778 of the power supply 731 can be used to house, at least in part, one or more components (e.g., energy metering module 747, controller 732) of the power supply 731, including one or more components of the controller 732. For example, as shown in FIG. 7, the controller 732 (which in this case includes the control engine 779, the communication module 785, the timer 788, the storage repository 756, the hardware processor 741, the memory 746, the transceiver 743, the application interface 726, the power module 727, and the optional security module 728) can be disposed within the cavity formed by the housing 778. In alternative embodiments, any one or more of these or other components of the power supply 731 can be disposed on the housing 778 and/or remotely from the housing 778.

The storage repository 756 can be a persistent storage device (or set of devices) that stores software and data used to assist the controller 732 in communicating with the user 777, the power source 733, the response circuit 780, and/or the load 707 within the system 700. In one or more example embodiments, the storage repository 756 stores stored data 757, protocols 758, and algorithms 759. The protocols 758 are generally one or more processes (e.g., a series of method steps) or procedures by which the controller 732 (or portions thereof) operates under a given set of conditions (e.g., time, readings by a sensor 783, measurements made by the energy metering module 747).

When the protocols 758 are communication protocols, the communication protocols can be any of a number of protocols that are used to send and/or receive data between the controller 732, the user 777, the power source 733, the response circuit 780, and/or the other load 707. One or more of the protocols 758 can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 758 can provide a layer of security to the data transferred within the system 700.

The algorithms 759 can be any formulas, logic steps, mathematical models, and/or other similar operational procedures that the control engine 779 of the controller 732 follows based on certain conditions at a point in time. For example, the controller 732 can use an algorithm 759 to determine (using a measurement made by a sensor 783) one or more parameters (e.g., temperature, pressure, humidity) proximate to the load 707, store (as stored data 759 in the storage repository 756) the resulting measurements, and evaluate the stored data 759 using one or more of the algorithms 759.

As another example, the controller 732 can use another algorithm 759 to continuously monitor the measurements made by the sensors 783, and use this data in combination with the feedback output received from the response circuit 780 to determine the power output generated by the power supply 731 and sent to the load 707. As another example, the controller 732 can use yet another algorithm 759 to measure one or more parameters of the system 700, and use this data to determine whether one or more characteristics (e.g., moisture content, temperature) is within acceptable parameters (also called threshold values, and also part of the stored data 759).

Stored data 759 can be any data associated with the system 700 (including any components thereof), any measurements taken by the sensors 783, measurements taken by the energy metering module 747, time measured by the timer 788, stored data 759 (e.g., threshold values, historical measured values), current ratings for the power supply 731, nameplate information associated with the various components (e.g., load 707, a sensor 783, a device) of the system 700, performance history of the one or more of the various components of the system 700, results of previously run or calculated algorithms 759, and/or any other suitable data. The stored data 759 can be associated with some measurement of time derived, for example, from the timer 788.

Examples of a storage repository 756 can include, but are not limited to, a database (or a number of databases), a file system, a hard drive, flash memory, some other form of solid state data storage, or any suitable combination thereof. The storage repository 756 can be located on multiple physical machines, each storing all or a portion of the stored data 757, protocols 758, and/or algorithms 759 according to some example embodiments. Each storage unit or device can be physically located in the same or in a different geographic location.

The storage repository 756 can be operatively connected to the control engine 779. In one or more example embodiments, the control engine 779 includes functionality to communicate with the user 777, the power source 733, the response circuit 780, and/or the load 707 in the system 700. More specifically, the control engine 779 sends information to and/or receives information from the storage repository 756 in order to communicate with the user 777, the power source 733, the response circuit 780, and/or the load 707. As discussed below, the storage repository 756 can also be operatively connected to the communication module 785 in certain example embodiments.

The controller 732 of FIG. 7 can be substantially the same as the controller described above. For example, in certain example embodiments, the controller 732 reads and interprets the readings of the energy metering module 747, reads and interprets the readings of the sensors 783, receives and interprets the feedback output from the response circuit 780 at the input channel 769, and uses this information to generate and send a power output to the load 707 through the output channel 768. In some cases, the controller 732 ensures that the power output of the power supply 731 is at a substantially constant power level. The controller 732 can also control, directly or indirectly, a setting of one or more sensors 783 and/or the energy metering module 747.

As discussed above, the control engine 779 of the controller 732 can manage (e.g., send power output to) a single load 707 or multiple loads 707 at a given point in time. Similarly, the control engine 779 of the controller 732 can manage (e.g., receive feedback output from) a single response circuit 780 or multiple response circuits 780 at a given point in time. In any case, the control engine 779 can ensure that each load 707 receives a substantially constant power output.

In certain example embodiments, the control engine 779 of the controller 732 controls the operation of one or more components (e.g., the communication module 785, the transceiver 743) of the controller 732. For example, the control engine 779 can put the communication module 785 in “sleep” mode when there are no communications between the controller 732 and another component (e.g., an load 707, the user 777) in the system 700 or when communications between the controller 732 and another component in the system 700 follow a regular pattern. In such a case, power consumed by the controller 732 is conserved by only enabling the communication module 785 when the communication module 785 is needed.

The control engine 779 can provide control, communication, and/or other similar signals to the user 777, the power source 733, the response circuit 780, and/or the load 707. Similarly, the control engine 779 can receive control, communication, and/or other similar signals from the user 777, the power source 733, the response circuit 780, and/or the load 707. The control engine 779 can control the power supply 731 or portions thereof (e.g., the sensors 783, switches) automatically (for example, based on one or more algorithms 759 stored in the storage repository 756) and/or based on control, communication, and/or other similar signals received from a controller of another component of the system 700 through the electrical conductors 701 and/or the communication links 776. The control engine 779 may include a printed circuit board, upon which the hardware processor 741 and/or one or more discrete components of the controller 732 can be positioned.

In certain example embodiments, the control engine 779 can include an interface that enables the control engine 779 to communicate with one or more components (e.g., communication module 785) of the power supply 731 and/or another component (e.g., the load 707, a user 777) of the system 700. For example, if the load 707 is one or more light-emitting diodes, and if the power supply 731 operates under IEC Standard 62386, then the output channel 768 can include a digital addressable lighting interface (DALI). In such a case, the control engine 779 (or other portion of the controller 732) can also include a DALI to enable communication with the power output channel 768 within the power supply 731. Such an interface can operate in conjunction with, or independently of, the protocols 758 used to communicate between the controller 732 and the user 777, the power source 733, the response circuit 780, and/or the load 707.

The control engine 779 can operate in real time. In other words, the control engine 779 of the controller 732 can process, send, and/or receive communications with the user 777, the load 707, the response circuit 780, and/or the power source 733 as any changes (e.g., discrete, continuous) occur within the system 700. Further, the control engine 779 of the controller 732 can, at substantially the same time, control the power supply 731, the power source 733, and/or an load 707 based on such changes.

In addition, the control engine 779 of the controller 732 can perform one or more of its functions continuously. For example, the controller 732 can continuously communicate stored data 757, results of algorithms 759, and/or any other information. In such a case, any updates or changes to such information (e.g., a change in power consumption measured by the energy metering module 747, and adjustment to an algorithm 759 based on actual data) can be used by the controller 732 in adjusting an output (e.g., current) sent by the controller 732 (or a portion thereof) to one or more output channels 768.

As yet another example, the control engine 779 can operate continuously to ensure that the instantaneous power output delivered to the output channel 768 by the power supply 731 at any point in time is substantially the same as the power output previously delivered. If there are multiple output channels 768, then the power output delivered to each output channel 768 by the power supply 731 at any point in time is substantially the same as the power output previously delivered to that output channel 768.

The control engine 779 (or other components of the controller 732) can also include one or more hardware and/or software architecture components to perform its functions. Such components can include, but are not limited to, a universal asynchronous receiver/transmitter (UART), a universal synchronous receiver/transmitter (USRT), a serial peripheral interface (SPI), a direct-attached capacity (DAC) storage device, an analog-to-digital converter, an inter-integrated circuit (I²C), and a pulse width modulator (PWM).

In certain example embodiments, the communication module 785 of the controller 732 determines and implements the communication protocol (e.g., from the stored data 757 of the storage repository 756) that is used when the control engine 779 communicates with (e.g., sends signals to, receives signals from) the user 777, the power source 733, the response circuit 780, and/or one or more of the load 707. In some cases, the communication module 785 accesses the protocols 758 to determine which communication protocol is within the capability of the recipient of a communication sent by the control engine 779. In addition, the communication module 785 can interpret the communication protocol of a communication received by the controller 732 so that the control engine 779 can interpret the communication.

The communication module 785 can send data directly to and/or retrieve data directly from the storage repository 756. Alternatively, the control engine 779 can facilitate the transfer of data between the communication module 785 and the storage repository 756. The communication module 785 can also provide encryption to data that is sent by the controller 732 and decryption to data that is received by the controller 732. The communication module 785 can also provide one or more of a number of other services with respect to data sent from and received by the controller 732. Such services can include, but are not limited to, data packet routing information and procedures to follow in the event of data interruption.

The power module 727 of the controller 732 provides power to one or more other components (e.g., timer 788, control engine 779) of the controller 732. In certain example embodiments, the power module 727 also generates the power output that is sent to the load 707 through the output channel 768 of the power supply 731. The power module 727 can include one or more of a number of single or multiple discrete components (e.g., transistor, diode, resistor), and/or a microprocessor. The power module 727 may include a printed circuit board, upon which the microprocessor and/or one or more discrete components are positioned. In some cases, the energy metering module 747 measures one or more elements of power (e.g., voltage, current) that is delivered to and/or sent from the power module 727,

The power module 727 can include one or more components (e.g., a transformer, a diode bridge, an inverter, a converter) that receives power (for example, through one or more electrical conductors 701) from a source (e.g., the power source 733) and generates power of a type (e.g., alternating current, direct current) and level (e.g., 12V, 24V, 470V) that can be used by the other components of the controller 732 as well as the load 707. The power module 727 can use a closed control loop to maintain a preconfigured power level with a tight tolerance at the output. The power module 727 can also protect the rest of the electronics (e.g., hardware processor 741, transceiver 743) from surges generated in the line. In addition, or in the alternative, the power module 727 can be a source of power in itself to provide signals to the other components of the controller 732. For example, the power module 727 can be a battery. As another example, the power module 727 can be a localized photovoltaic power system.

The hardware processor 741 of the controller 732 executes software in accordance with one or more example embodiments. Specifically, the hardware processor 741 can execute software on the control engine 779 or any other portion of the controller 732, as well as software used by the user 777, the power source 733, the response circuit 780, and/or one or more of the load 707. The hardware processor 741 can be an integrated circuit, a central processing unit, a multi-core processing chip, a multi-chip module including multiple multi-core processing chips, or other hardware processor in one or more example embodiments. The hardware processor 741 is known by other names, including but not limited to a computer processor, a microprocessor, and a multi-core processor.

In one or more example embodiments, the hardware processor 741 executes software instructions stored in memory 746. The memory 746 includes one or more cache memories, main memory, and/or any other suitable type of memory. The memory 746 is discretely located within the controller 732 relative to the hardware processor 741 according to some example embodiments. In certain configurations, the memory 746 can be integrated with the hardware processor 741. In certain example embodiments, the controller 732 does not include a hardware processor 741. In such a case, the controller 732 can include, as an example, one or more FPGAs, one or more IGBTs, and/or one or more ICs. Using FPGAs, IGBTs, ICs, and/or other similar devices known in the art allows the controller 732 (or portions thereof) to be programmable and function according to certain logic rules and thresholds without the use of a hardware processor. Alternatively, FPGAs, IGBTs, ICs, and/or similar devices can be used in conjunction with one or more hardware processors 741.

The transceiver 743 of the controller 732 can send and/or receive control and/or communication signals. Specifically, the transceiver 743 can be used to transfer data between the controller 732 and the user 777, the power source 733, the response circuit 780, and/or the load 707. The transceiver 743 can use wired and/or wireless technology, using the electrical conductors 701 and/or the communication links 776. The transceiver 743 can be configured in such a way that the control and/or communication signals sent and/or received by the transceiver 743 can be received and/or sent by another transceiver that is part of the user 777, the power source 733, the response circuit 780, and/or the load 707.

When the transceiver 743 uses wireless technology as the communication link 776, any type of wireless technology can be used by the transceiver 743 in sending and receiving signals. Such wireless technology can include, but is not limited to, Wi-Fi, visible light communication, cellular networking, and Bluetooth. The transceiver 743 can use one or more of any number of suitable communication protocols (e.g., ISA100, HART) when sending and/or receiving signals. Such communication protocols can be dictated by the communication module 785. Further, any transceiver information for the user 777, the power source 733, the response circuit 780, and/or the load 707 can be stored in the storage repository 756.

Optionally, in one or more example embodiments, the security module 728 secures interactions between the controller 732, the user 777, the power source 733, the response circuit 780, and/or the load 707. More specifically, the security module 728 authenticates communication from software based on security keys verifying the identity of the source of the communication. For example, user software may be associated with a security key enabling the software of the user 777 to interact with the controller 732, the power source 733, the response circuit 780, and/or the load 707. Further, the security module 728 can restrict receipt of information, requests for information, and/or access to information in some example embodiments.

One or more of the functions performed by any of the components (e.g., controller 732) of an example power supply 731 can be performed using a computing device 840. An example of a computing device 840 is shown in FIG. 8. The computing device 840 implements one or more of the various techniques described herein, and which is representative, in whole or in part, of the elements described herein pursuant to certain example embodiments. Computing device 840 is one example of a computing device and is not intended to suggest any limitation as to scope of use or functionality of the computing device and/or its possible architectures. Neither should computing device 840 be interpreted as having any dependency or requirement relating to any one or combination of components illustrated in the example computing device 840.

Computing device 840 includes one or more processors or processing units 818, one or more memory/storage components 819, one or more input/output (I/O) devices 848, and a bus 849 that allows the various components and devices to communicate with one another. Bus 849 represents one or more of any of several types of bus structures, including a memory bus or memory controller, a peripheral bus, an accelerated graphics port, and a processor or local bus using any of a variety of bus architectures. Bus 849 includes wired and/or wireless buses.

Memory/storage component 819 represents one or more computer storage media. Memory/storage component 819 includes volatile media (such as random access memory (RAM)) and/or nonvolatile media (such as read only memory (ROM), flash memory, optical disks, magnetic disks, and so forth). Memory/storage component 819 includes fixed media (e.g., RAM, ROM, a fixed hard drive, etc.) as well as removable media (e.g., a Flash memory drive, a removable hard drive, an optical disk, and so forth).

One or more I/O devices 848 allow a customer, utility, or other user to enter commands and information to computing device 840, and also allow information to be presented to the customer, utility, or other user and/or other components or devices. Examples of input devices include, but are not limited to, a keyboard, a cursor control device (e.g., a mouse), a microphone, and a scanner. Examples of output devices include, but are not limited to, a display device (e.g., a monitor or projector), speakers, a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 840 is connected to a network (not shown) (e.g., a local area network (LAN), a wide area network (WAN) such as the Internet, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 840 includes at least the minimal processing, input, and/or output means necessary to practice one or more embodiments.

Further, those skilled in the art will appreciate that one or more elements of the aforementioned computer device 840 is located at a remote location and connected to the other elements over a network in certain example embodiments. Further, one or more embodiments is implemented on a distributed system having one or more nodes, where each portion of the implementation (e.g., controller 732) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

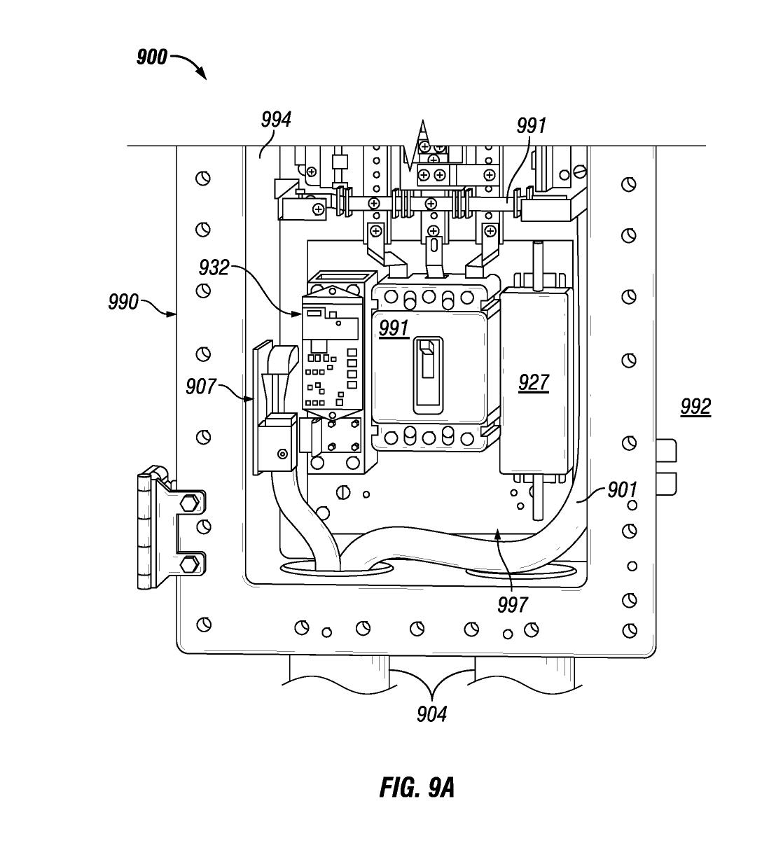

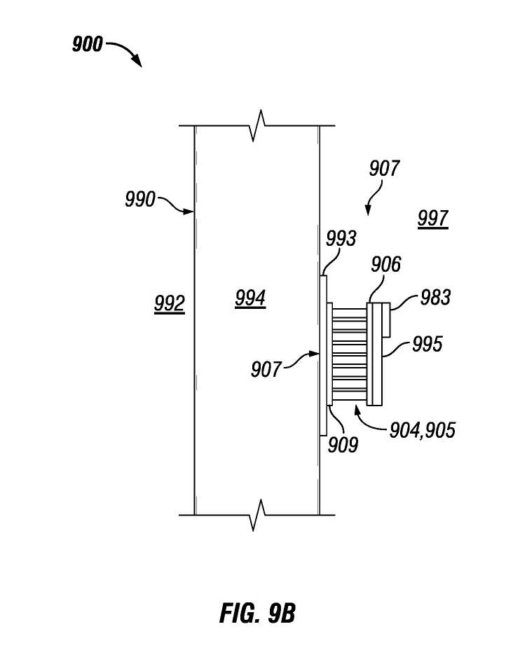

FIGS. 9A and 9B show a system 900 in which one or more example embodiments can be used. Specifically, FIG. 9A shows a front view of the lower half of an open electrical enclosure 990 inside of which an example power module 927 is disposed. FIG. 9B shows a side view of the load 907 (in this case, a TEC) served by the power supply 931. Referring to FIGS. 1-9B, the enclosure 900 of FIGS. 9A and 9B is an electrical enclosure that shows the cover removed from the body of the enclosure 900. The body can have any of a number of shapes (e.g., spherical). In this case, the body is in the shape of an elongated cube. The body is defined by at least one wall 994 that forms a cavity 997. When the cover is affixed to the body, the cavity 997 is enclosed.

Within the cavity 997 of the enclosure 990 of FIGS. 9A and 9B are disposed a number of devices 991 (e.g., circuit breakers, bus bars, electrical conductors 901, the power module 927, the controller 932 of the power supply 931) that can be adversely affected by excessive exposure to one or more abnormal ambient conditions (e.g., high humidity, moisture, high temperature) within the cavity 997. In this case, since the load 907 is a TEC, the load 907 can be used to regulate the ambient conditions within the cavity 997, thereby extending the useful life of the devices 910.

The load 927 (in this case, TEC) of FIGS. 9A and 9B is coupled to an inner surface of a wall 994 of the body of the enclosure 990. The TEC in this case can be substantially similar to the TEC described above. For example, a number of p-type semiconductors 905 and a number of n-type semiconductors 904 are sandwiched between a cool plate 906 and a hot plate 909. The load 907 transfers heat from air in the cavity 997 of the enclosure 990 into the outer wall 994 of the body of the enclosure 990.

Optionally, disposed between the hot plate 909 and the inner surface of the outer wall 994 of the body of the enclosure 990 can be disposed a thermal interface material 993, which can be used to provide continuity between uneven surfaces of the hot plate 909 and/or the inner surface of the outer wall 994 of the body of the enclosure 990 for increased thermal transfer between the hot plate 909 and the inner surface of the outer wall 994 of the body of the enclosure 990. With or without the thermal interface material 993, the hot plate 909 is in thermal communication with the inner surface of the outer wall 994 of the body of the enclosure 990. When the TEC is activated, the wall 994 of the body of the enclosure 990 provides enough thermal mass to maintain a relatively low temperature at the hot plate 909.

The cold plate 906 can be exposed directly to the cavity 997 of the enclosure 900. Alternatively, as shown in FIG. 9B, a cold sink 995 (e.g., a hydro-phobic coating, a metal layer) can be disposed over some or all of the cold plate 906. The cold sink 995 can be used to prevent the cold plate 906 from allowing condensation that collects on the cold plate 906 to freeze. In some cases, the cold sink 995 can be used to have condensation that accumulates on the cold plate 906 (or the cold sink 995) be repelled by the cold sink 995.

In certain example embodiments, the load 927 can include a sensor device 983 (e.g., a negative temperature coefficient (NTC) thermistor) can be used to measure a parameter (e.g., a temperature) within the cavity 997 of the enclosure 990. For example, the sensor device 983 shown in FIG. 9B is attached to the cold sink 995 and can measure the temperature of the cold plate 906. In such a case, the temperature of the cold plate 906 can be important to maintain below the dew point and above freezing to ensure proper operation of the TEC.

In some cases, the system 900 within the cavity 997 of the enclosure 990 can include one or more other components (e.g., an air moving device, such as a diaphragm pump, a fan, or a blower) to provide air movement (e.g., forced convection) in the cavity 997 of the enclosure 990 to ensure that the moist air within the cavity 997 is moved toward the load 927 (in this case, the TEC). When the TEC is placed against a thermal component (e.g., a heat sink, the wall 994 of the enclosure body), the TEC lowers the temperature of the thermal component (at least locally), which can enable the condensation of moisture from the air within the cavity 997 of the enclosure 990 with little to no increase in air temperature within the cavity 997 of the enclosure 990.

When the thermal component is cooled by the TEC, convective air currents can result within the cavity 997 of the enclosure 990. When this occurs, the entire air volume of the cavity 997 passes across the thermal component, resulting in the dehumidification of all (or substantially all) of the air within the cavity 997. In such a case, there can be an accumulation of liquid on or near the thermal component. As a result, the enclosure 990 can include a drain and/or other device to remove the moisture accumulated within the cavity 997. In addition, or in the alternative, in certain example embodiments, an air moving device (e.g., a fan, a blower) can be installed within the cavity 997 of the enclosure 990 to further ensure all air passes across the thermal component that is cooled by the TEC.

In some cases, the power polarity of the TEC can be reversed, which heats (at least locally) the thermal component to which the TEC is affixed. This application could be useful for situations where the ambient environment 992 in which the enclosure 990 is disposed has very low temperatures. In such a case, the TEC can be used to heat the cavity 997 of the enclosure 990 and thereby heat up the devices 991 to a temperature that approaches the lower specification limit for the devices 991. In such conditions, the removal of liquid from within the cavity 997 of the enclosure 990 would be of negligible concern.

As discussed above, an enclosure (e.g., enclosure 990) can be placed in a hazardous environment. In such a case, as in FIGS. 9A and 9B, where the ambient environment 992 is hazardous, the enclosure 990 can be designed to meet certain standards (e.g., NEMA 7) to ensure safe operation within that ambient environment 992. For example, the enclosure 990 can be an explosion-proof enclosure with proper flame paths, as discussed above.

Example embodiments can provide for environmental (e.g., temperature, humidity, moisture) control systems for electrical enclosures or other environments. Specifically, certain example embodiments can allow for a supply of substantially constant power to TECs and/or other similar devices that control one or more conditions (e.g., moisture, temperature) within an electrical enclosure or other environment. Alternatively, example embodiments can be used to compensate for conditions that naturally occur with an electrical device effected by conditions such as temperature. For example, example embodiments can be used to allow a LED to emit a substantially constant light output, regardless of warm up status. Generally, example response circuits allow for more reliable operation of TECs and/or other electrical devices by providing constant power, regardless of temperatures (e.g., ambient, differentials) and/or other factors that can affect the performance of such a device. Example embodiments can be used in retrofit applications of existing circuitry or as part of a new installation.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. An electrical circuit comprising:
a power supply that generates a power output;
a load that receives the power output from the power supply;
an electrical conductor coupled to the power supply and the load, wherein the electrical conductor emits a magnetic field when the power output flows through the electrical conductor to the load; and
a response circuit coupled to the power supply and disposed proximate to the electrical conductor, wherein the response circuit generates a feedback output based on the magnetic field, and wherein the power output generated by the power supply is based on the feedback output.

2. The electrical circuit of claim 1, wherein the load comprises a thermo-electric cell.

3. The electrical circuit of claim 1, wherein the load comprises at least one light-emitting diode.

4. The electrical circuit of claim 1, further comprising:
at least one bias power source that provides bias power to the response circuit.

5. The electrical circuit of claim 4, wherein the at least one bias power source comprises a bias current source and a bias voltage source.

6. The electrical circuit of claim 4, wherein the at least one bias power source is powered by a source independent of the power supply.

7. The electrical circuit of claim 1, wherein the power output generated by the power supply, when based on the feedback output, is derived from a substantially constant power level over time.

8. The electrical circuit of claim 7, wherein the power output generated by the power supply, without the feedback output, is at a substantially constant voltage level over time.

9. The electrical circuit of claim 7, wherein the power output generated by the power supply, without the feedback output, is at a substantially constant current level over time.

10. The electrical circuit of claim 7, wherein the load and the response circuit are exposed to a range of temperatures over time.

11. The electrical circuit of claim 1, wherein the power supply comprises a controller, wherein the controller comprises an output channel and a feedback channel.

12. The electrical circuit of claim 11, wherein the output channel of the controller delivers the power output to the load, and wherein the feedback channel adjusts the power output based on the feedback output received from the response circuit.

13. The electrical circuit of claim 1, wherein the feedback output generated by the response circuit comprises a voltage and a current.

14. The electrical circuit of claim 1, wherein the response circuit comprises a bias circuit and a sensor circuit, wherein the sensor circuit is activated when power flows through the bias circuit, and wherein the sensor circuit, when activated, measures the magnetic field.

15. The electrical circuit of claim 14, wherein the magnetic field is generated when the power output is received by the load.

16. A power supply for providing a substantially constant level of power to a load, the power supply comprising:
a first input channel configured to receive main power from a power source;
a second input channel configured to receive feedback output from a response circuit;
an output channel configured to deliver the substantially constant level of power to the load; and
a controller that receives the feedback output through the second input channel and generates, based on the output from the feedback output, the substantially constant level of power.

17. A system comprising:
an enclosure comprising at least one wall that forms a cavity;
a device disposed within the cavity, wherein the device is adversely affected by an abnormal ambient condition within the cavity;
a power supply that generates a power output;
a load disposed within the cavity, wherein the load receives the power output from the power supply, and wherein the load reduces the moisture within the cavity;
an electrical conductor coupled to the power supply and the load, wherein the electrical conductor is disposed within the cavity and emits a magnetic field when the power output flows through the electrical conductor to the load; and
a response circuit coupled to the power supply and disposed proximate to the electrical conductor within the cavity, wherein the response circuit generates a feedback output based on the magnetic field, and wherein the power output generated by the power supply is based on the feedback output.

18. The system of claim 17, wherein the enclosure is rated for a hazardous environment.

19. The system of claim 17, wherein the power output generated by the power supply is substantially constant.

20. The system of claim 17, wherein the abnormal ambient condition comprises at least one of a group consisting of a high temperature, a low temperature, high humidity, and moisture.
